(19) United States
(12) Patent Application Publication
(10) Pub. No.: US 2006/0274649 A1
(43) Pub. Date: Dec. 7, 2006

(54) Method and apparatus for rerouting non-unicast traffic

(75) Inventor: Thomas Scholl, New Haven, CT (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/145,794

(22) Filed: Jun. 6, 2005

(51) Int. Cl. H04J 3/14; H04L 12/56

(52) U.S. Cl. 370/218; 370/389

(57) ABSTRACT

A network element (102) coupled to one or more neighboring network elements with built-in router redundancy has an active router (202) programmed to detect (201) an interruption in communication at a select one of the neighboring network elements which has in response switched to a redundant router, and reroute (212) non-unicast traffic to one or more unaffected network elements.

### FIELD OF THE INVENTION

This invention relates generally to packet routing, and more particularly to a method and apparatus for rerouting non-unicast traffic.

### BACKGROUND OF THE INVENTION

Under normal circumstances, conventional packet routers can handle a multitude of traffic types such as, for instance, unicast (point-to-point) traffic, and non-unicast (point-to-multipoint) traffic such as multicast and/or MPLS (Multi-Protocol Label Switching) traffic. Legacy routers employ hardware redundancy to improve the robustness of the network. Protocols such as NSF (Non-Stop Forwarding) are used to inform other routers of this redundancy.

Before the convergence of voice, video, and data, protocols operating in legacy routers were designed primarily for unicast traffic. Consequently, when legacy routers switch to their backup router, said backup systems cease to accept non-unicast traffic. It can take anywhere from thirty to sixty seconds to recover and reestablish end-to-end communications after a non-unicast traffic interruption such as this. Such downtime can aggravate consumers who rely on such services. This is especially true for customers who expect near real-time services with minimal interruptions.

### SUMMARY OF THE INVENTION

Embodiments in accordance with the invention provide a method and apparatus for method and apparatus for rerouting non-unicast traffic.

In a first embodiment of the present invention, a network element coupled to one or more neighboring network elements with built-in router redundancy has an active router programmed to detect an interruption in communication at a select one of the neighboring network elements which has in response switched to a redundant router, and reroute non-unicast traffic to one or more unaffected network elements.

In a second embodiment of the present invention, a network element coupled to one or more neighboring network elements with built-in router redundancy has a computer-readable storage medium. The storage medium includes computer instructions for detecting an interruption in communication at a select one of the neighboring network elements which has in response switched to a redundant router, and rerouting non-unicast traffic to one or more unaffected network elements.

In a third embodiment of the present invention, a network element coupled to one or more neighboring network elements with built-in router redundancy operates according to a method having the steps of detecting an interruption in communication at a select one of the neighboring network elements which has in response switched to a redundant router, and rerouting non-unicast traffic to one or more unaffected network elements.

### BRIEF DESCRIPTION OF THE DRAWINGS

FIG. 1 is block diagram of a communication system according to an embodiment of the present invention;

FIG. 2 is a block diagram of a network element of the communication system according to an embodiment of the present invention; and

FIG. 3 depicts a flowchart of a method operating in the network element according to an embodiment of the present invention.

### DETAILED DESCRIPTION OF THE DRAWINGS

While the specification concludes with claims defining the features of embodiments of the invention that are regarded as novel, it is believed that the embodiments of the invention will be better understood from a consideration of the following description in conjunction with the figures, in which like reference numerals are carried forward.

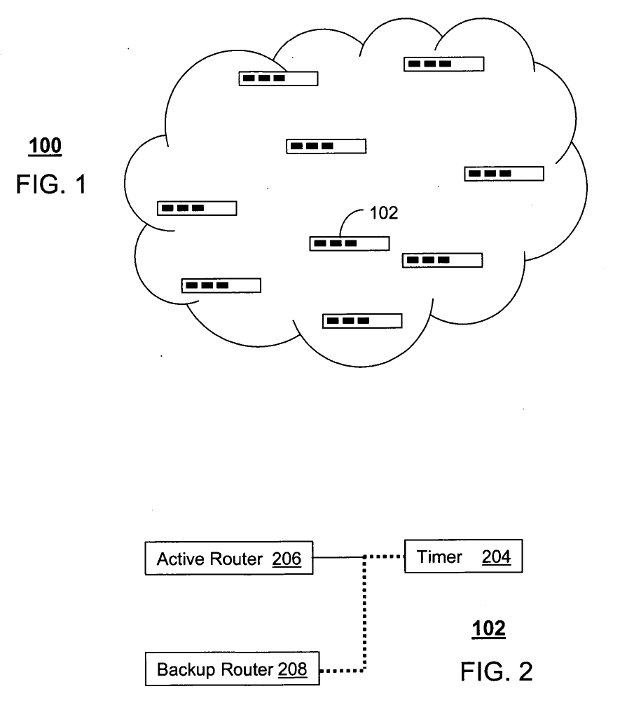

FIG. 1 is block diagram of a communication system 100 according to an embodiment of the present invention. The communication system 100 comprises a plurality of network elements 102 each capable of routing packets of information among them for end-to-end communication between end users of the communication network. During normal operations, the network elements 102 of the communication system are capable of routing unicast (point-to-point) traffic, and/or non-unicast traffic such as MPLS (Multi-Protocol Label Switching) traffic or multicast traffic. The network elements 102 can utilize conventional routing protocols such as the IS-IS (Intermediate System-to-Intermediate System) or OSPF (Open Shortest Path First) protocols for routing traffic. Typical traffic consists of data transfers, active video, VoIP (Voice over IP), streaming video and/or audio—just to mention a few.

FIG. 2 is a block diagram of a network element 102 of the communication system 100 according to an embodiment of the present invention. In its simplest embodiment, the network element 102 comprises an active router 202. The active router 202 utilizes conventional routing technology for routing unicast and non-unicast traffic to neighboring network elements 102. The active router 202 can comprise a computing technology such as one or more microprocessors and/or DSPs (Digital Signal Processors). The active router 202 can further utilize conventional storage devices such as a mass storage media (like a high capacity disk drive), floppy disks, Dynamic or Static Random Access Memories, Read Only Memories, and/or Flash memories.

In a supplemental embodiment, the network element 102 includes a backup router 208 and a timer 104. The backup router 208 is substantially similar in design and functionality as the active router 202 (i.e., having similar computing technology and memory). Said router 208 utilizes conventional technology for maintaining routing of unicast traffic when a failure is detected in the active router 202. The timer 204 utilizes conventional technology for tracking temporal events pertinent to the operation of network element 102.

Network elements 102 such as have been described can be supplied by manufacturers such as Cisco Systems™ and Juniper Networks™.

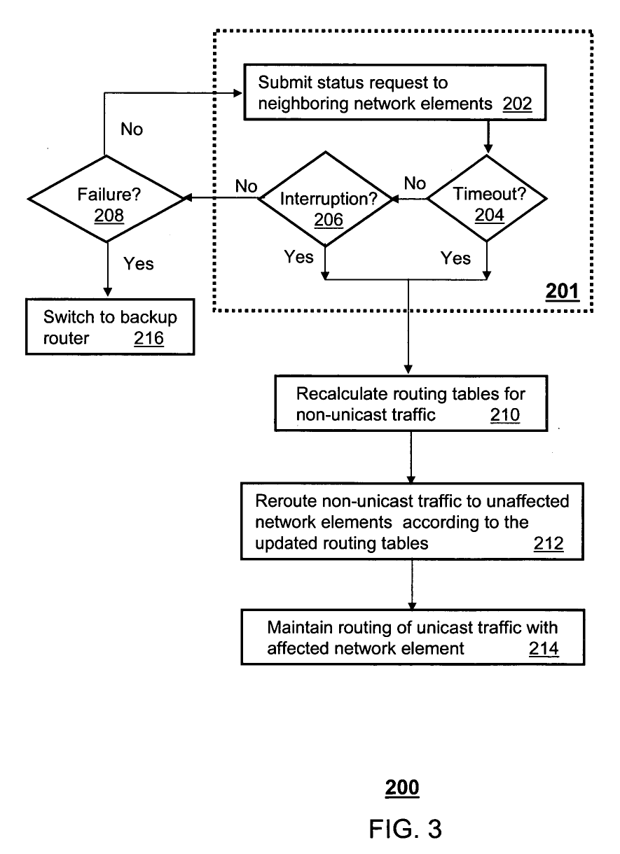

FIG. 3 depicts a flowchart of a method 200 operating in the network element 102 according to an embodiment of the present invention. Method 200 begins with step 201 where the active router 202 is programmed to detect an interruption in communication at a select one of the neighboring network elements 102 which has in response switched to a redundant router (such as the backup router 208 described earlier). The term “neighboring” as used in the present context can mean network elements immediately adjacent or outside the immediate vicinity of the network element 102 in question.

The detection step 201 can take on any number of embodiments, one of which is depicted in FIG. 3 as steps 202 and 204. In this embodiment, the active router 202 submits a status request to neighboring network elements 102. The status request can be a simple message requesting an operational response from the neighboring network elements 102. The status request can be implemented as part of the IS-IS or OSPF protocols mentioned earlier. It would be obvious to an artisan with skill in the art that other protocols or monitoring techniques can be used.

If a response from a neighboring network element 102 is received before a predetermined timeout period (e.g., 100 ms) monitored in step 204, then the active router 202 proceeds to step 206 to analyze the response. If said response is indicative that there's no interruption in communication (i.e., the active router remains operational), then the active router 202 proceeds to step 208 to check that its own active router 202 is operating property. If a failure is not detected, then the active router 202 proceeds to step 202 where it repeats the aforementioned cycle. The active router 202 can implement the timeout period in step 204 with a software timer or with the assistance of the hardware timer 204 of FIG. 2. Additionally, the monitoring steps can be repeated as many times as deemed necessary.

On the other hand, when a neighboring network element 102 fails to respond as detected by a timeout event in step 204, or the response indicates in step 206 that an interruption in communication has occurred, the active router 202 proceeds to steps 210, 212 and 214 to proactively mitigate an anticipated interruption with non-unicast traffic. As noted earlier in the background, when legacy routers switch to a backup system, non-unicast traffic can no longer be routed, and packet losses ensue. The same is not true, however, for unicast traffic. That is, backup routers can continue to route unicast traffic. To overcome this limitation in the art, the active router 202 can be programmed to recalculate in step 210 its routing tables for non-unicast traffic. In step 212, the active router 202 reroutes the non-unicast traffic to one or more unaffected network elements 102 according to said updated tables. Since unicast traffic remains unaffected, the active router 202 can continue to route unicast traffic in step 214 to the affected network element 102. The active router 202 can be programmed to remain in this state until such time that the affected network element 102 is repaired or recovers.

As noted by step 208, the network element 102 can monitor its own operations. If the active router 202 fails for any reason (e.g., hardware or software interruption), the backup router 208 is enabled and begins to process unicast data. Any conventional means for detecting a failure in the active router 202 can be used for enabling this switch.

It should be evident from the foregoing embodiments that the present invention can be realized in hardware, software, or a combination of hardware and software. Moreover, the present invention can be realized in a centralized fashion, or in a distributed fashion where different elements are spread across several interconnected processors. Any kind of computer device or other apparatus adapted for carrying out method 200 described above is suitable for the present invention.

Additionally, the present invention can be embedded in a computer program product, which comprises all the features enabling the implementation of method 200, and which when loaded in a computer system is able to carry out these methods as computer instructions. A computer program in the present context means any expression, in any language, code or notation, of a set of instructions intended to cause a system having an information processing capability to perform a particular function either directly or after either or both of the following: a) conversion to another language, code or notation; b) reproduction in a different material form.

It should be also evident from the embodiments of FIG. 3 that the present invention may be used for many applications. Thus, although the description is made for particular arrangements and methods, the intent and concept of the invention is suitable and applicable to other arrangements and applications not described herein. For example, method 200 can be reduced to steps 201 and 212 without departing from the claimed invention. In this reduced embodiment, the new routing tables can be predefined, and the technique for detection can be based on a technique whereby the network elements 102 proactively transmit their status rather than being probed. From this example, it would be clear therefore to those skilled in the art that modifications to the disclosed embodiments described herein could be effected without departing from the spirit and scope of the invention.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, other re-writable (volatile) memories or Signals containing instructions. A digital file attachment to e-mail or other self-contained information archive or set of archives sent through signals is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

Accordingly, the described embodiments ought to be construed to be merely illustrative of some of the more prominent features and applications of the invention. It should also be understood that the claims are intended to cover the structures described herein as performing the recited function and not only structural equivalents. Therefore, equivalent structures that read on the description should also be construed to be inclusive of the scope of the invention as defined in the following claims. Thus, reference should be made to the following claims, rather than to the foregoing specification, as indicating the scope of the invention.

What is claimed is:

1. A network element coupled to one or more neighboring network elements with built-in router redundancy, comprising:
an active router programmed to:
detect an interruption in communication at a select one of the neighboring network elements which has in response switched to a redundant router; and
reroute non-unicast traffic to one or more unaffected network elements.

2. The network element of claim 1, comprises a timer, and wherein the active router is programmed to:
submit a status request to the neighboring network elements; and
detect an interruption in communicating when a network element fails to respond within a predetermined time.

3. The network element of claim 1, wherein the non-unicast traffic comprises one among MPLS (Multi-Protocol Label Switching) traffic and multicast traffic.

4. The network element of claim 1, wherein the active router is programmed to maintain routing of unicast traffic to the affected network element.

5. The network element of claim 1, wherein the active router is programmed to:
recalculate routing tables for the non-unicast traffic; and
reroute non-unicast traffic to one or more unaffected network elements according to said updated tables.

6. The network element of claim 1, wherein the active router operates according to one among a group of routing protocols comprising an IS-IS (Intermediate System-to-Intermediate System) protocol and an OSPF (Open Shortest Path First) protocol.

7. The network element of claim 1, comprising a backup router, and wherein the backup router is programmed to process unicast traffic upon detecting an interruption in communication in the active router.

8. In a network element coupled to one or more neighboring network elements with built-in router redundancy a computer-readable storage medium, comprising computer instructions for:
detecting an interruption in communication at a select one of the neighboring network elements which has in response switched to a redundant router; and
rerouting non-unicast traffic to one or more unaffected network elements.

9. The storage medium of claim 8, comprising computer instructions for:
submitting a status request to the neighboring network elements; and
detecting an interruption in communicating when a network element fails to respond within a predetermined time.

10. The storage medium of claim 8, wherein the non-unicast traffic comprises one among MPLS (Multi-Protocol Label Switching) traffic and multicast traffic.

11. The storage medium of claim 8, comprising computer instructions for maintaining routing of unicast traffic to the affected network element.

12. The storage medium of claim 8, comprising computer instructions for:
recalculating routing tables for the non-unicast traffic; and
rerouting non-unicast traffic to one or more unaffected network elements according to said updated tables.

13. The storage medium of claim 8, wherein a router of the network element operates according to one among a group of routing protocols comprising an IS-IS (Intermediate System-to-Intermediate System) protocol and an OSPF (Open Shortest Path First) protocol.

14. The storage medium of claim 8, comprising computer instructions for processing unicast traffic at a backup router of the network element upon detecting an interruption in communication in an active router of said network element.

15. In a network element coupled to one or more neighboring network elements with built-in router redundancy, a method comprising the steps of:
detecting an interruption in communication at a select one of the neighboring network elements which has in response switched to a redundant router; and
rerouting non-unicast traffic to one or more unaffected network elements.

16. The method of claim 15, comprising the steps of:
submitting a status request to the neighboring network elements; and
detecting an interruption in communicating when a network element fails to respond within a predetermined time.

17. The method of claim 15, comprising the steps of:
maintaining routing of unicast traffic to the affected network element;
recalculating routing tables for the non-unicast traffic; and
rerouting non-unicast traffic to one or more unaffected network elements according to said updated tables.

18. The method of claim 15, comprising the step of processing unicast traffic at a backup router of the network element upon detecting an interruption in communication in an active router of said network element.

19. The method of claim 15, wherein the non-unicast traffic comprises one among MPLS (Multi-Protocol Label Switching) traffic and multicast traffic.

20. The method of claim 15, wherein a router of the network element operates according to one among a group of routing protocols comprising an IS-IS (Intermediate System-to-Intermediate System) protocol and an OSPF (Open Shortest Path First) protocol.
